(19) United States
(12) Patent Application Publication
(10) Pub. No.: US 2007/0012604 A1
(43) Pub. Date: Jan. 18, 2007

(54) Sorter

(75) Inventor: Adam Martyn Basford, Southampton (GB)

Correspondence Address: PATTERSON & SHERIDAN L.L.P., 595 SHREWSBURY AVE, STE 100, FIRST FLOOR, SHREWSBURY, NJ, 07702, US

(73) Assignee: RADIX SYSTEMS LIMITED

(21) Appl. No.: 11/484,932

(22) Filed: Jul. 12, 2006

(30) Foreign Application Priority Data
Jul. 13, 2005 (GB) 0514420.9

(51) Int. Cl. B07C 5/00

(52) U.S. Cl. 209/644

(57) ABSTRACT

A sorter ejects defective products from a stream of product delivered to a sorting zone. A camera (6) has a line of sight (5) to the sorting zone and provides an image of the stream at the safety zone. A blast bar (3) generates one or more air jets directed at the safety zone. A processor (9) processes the image to detect defective products and causes the blast bar to eject defective products from the safety zone. The zone of impingement of the air jet(s) on the stream is downstream of the line of sight and the blast bar is upstream of the line of sight.

### BACKGROUND

The present invention relates to a system for sorting products. Embodiments of the invention relate to removing impurities from products or separating defective products from acceptable products.

The accompanying FIG. 1 is a schematic cross-sectional view of a known sorting system of Radix Systems Limited.

A delivery means, in this example a vibratory feed 1 and a delivery chute 2, delivers unsorted product to a sorting zone 10. The product is a mixture of acceptable samples of the product and defective samples of the product. In the sorting zone 10 the defective samples are separated from the acceptable samples, the acceptable samples being collected in a collecting bin 7 and the rejected samples collected in a collecting bin 8.

In order to sort the products in the sorting zone there is provided cameras 6 and 6′ on opposite sides of the sorting zone having lines of sight 5 and 5′ to the sorting zone. A processing unit 9 processes the image signals provided by the cameras 6 and 6′ and produces control signals controlling the operation of a “blast bar” 3. The blast bar is a fluid jet generator which is controlled by the processor 9 to produce one or more fluid jets to divert defective products into the collecting bin 8. Acceptable products are not deflected from their paths and fall in to the acceptable product collecting bin 7.

The delivery means 1, 2 delivers a stream of product to the sorting zone. The stream of product falls through the sorting zone. If all the products were acceptable, the stream would fall in to the acceptable product collecting bin 7. The blast bar 3 ejects defective products from the stream and they are collected in the defective product collecting bin 8.

The sorting zone is illuminated by lights 4. In this example there are two lights 4 between sorting zone 10 and the camera 6 and there is one light 4 between the sorting zone 10 and the camera 6′.

The position at which the fluid jet produced by the blast bar 3 impinges on the product stream is downstream of the line of sight of the cameras 6 and 6′. The blast bar 3 itself is also downstream of the line of sight as is conventional. Other examples of sorting systems having different configurations all have the blast bar downstream of the line of sight.

### SUMMARY

According to the present invention there is provided a sorter comprising:

a delivery device arranged to deliver a stream of product to a sorting zone through which the stream falls;

at least one camera operable to provide an image of the said stream at the sorting zone, the camera having a line of sight to the sorting zone;

a generator operable to generate a fluid jet directed at the sorting zone to impinge on the stream at a zone of impingement; and

a processor arranged to process the image provided by the said at least one camera to detect a product having predetermined characteristics and to cause the fluid jet generator to direct the fluid jet at the detected product in the zone of impingement to eject it from the stream;

wherein the zone of impingement of the fluid jet on the stream is downstream of the line of sight and the fluid jet generator is upstream of the line of sight.

The product having a predetermined characteristic and which is ejected may be a defective product or an impurity in the product stream.

The fluid jet generator is upstream of the line of sight and directs the fluid jet so that it passes through the line of sight of the camera before impinging on the stream of product.

In the known system of FIG. 1 and in other known systems, the fluid jet generator is on the downstream side of the line of sight away from the delivery means and the fluid jet passes through the line of sight after impinging on the stream of the product.

An embodiment of the present invention has the advantage that, in practice, the fluid jet can be directed closer to the line of sight. That is advantageous especially for non-uniform products. The camera and processor can detect the product before it reaches the impingement zone. It is generally assumed that there is a fixed delay between detection of a defective product and the product reaching the impingement zone. The fluid jet can be actuated after the fixed delay to eject defective products. However, the time the product actually takes to reach the impingement zone will vary from sample to sample of the product especially for a non-uniform product. The time taken by the product to move from the line of sight to the impingement zone will vary more the greater the distance between the line of sight and the impingement zone Another advantage is also provided. Many objects (peas for example) tend to swerve as they slide/roll down a chute with the result that they may well not have travelled in a direction normal to the line of site, so moving laterally by the time they reach to the impingement zone.

An embodiment of the invention can reduce lateral movement between the line of sight and the impingement zone.

Allowing the impingement zone to be closer to the line of sight reduces the delay and increases the likelihood that defective products, once detected, are ejected from the stream.

Greater flexibility can be provided in positioning of the cameras. In embodiments of the invention at least one light is provided for illuminating the stream of product. Greater flexibility in positioning of the light or lights can be provided.

In embodiments the fluid jet generator generates jets of air.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 is a schematic cross-sectional view of a known sorter as described above;

FIG. 2 is a schematic cross-section view of an example of a sorter according to the invention; and

FIG. 3 is a schematic perspective view of another example of a sorter according to the invention.

### DESCRIPTION OF EMBODIMENTS

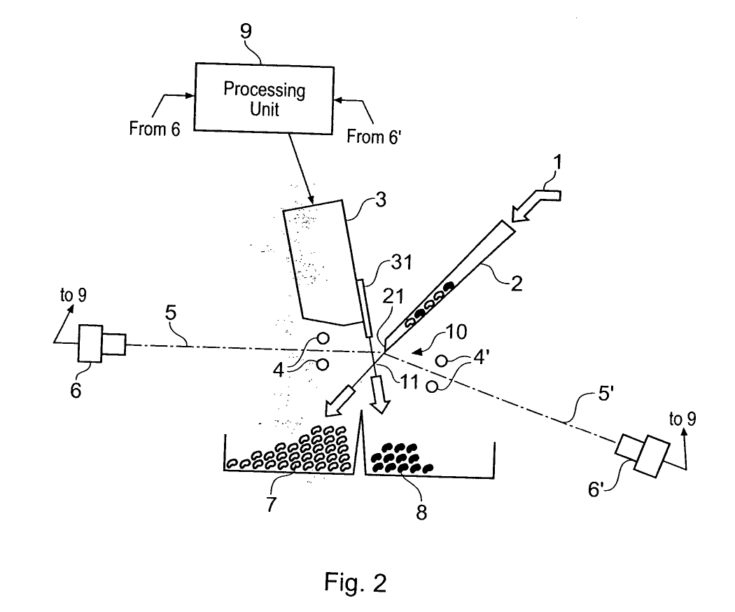

Referring to FIG. 2, a product delivery device 1, 2 delivers a stream of product to a sorting zone 10. The product delivery means comprises an inclined chute 2 to which product is delivered by a delivery device such as a conveyor schematically indicated at 1. The product stream extends over the width of the chute: i.e. perpendicularly to the plane of the drawing. The sorting zone is illuminated by lights 4. The illuminated sorting zone is viewed by cameras 6 and 6′ on opposite sides of the sorting zone. The lines of sight 5 and 5′ of the cameras 6 and 6′ pass between pairs of lights 4 and 4′ on each side of the sorting zone and meet closely adjacent to, but downstream of, the lower end 21 of the chute 2.

The cameras 6 and 6′ provide, to a processing unit 9, image signals representing the product stream falling through the sorting zone 10. The processing unit 9 detects defective products and controls a blast bar 3 which extends over the width of the product stream to eject defective products from the product stream provided by the chute 2. Acceptable product falls through the sorting zone 10 into an acceptable product collecting bin 7. The defective product is ejected from the stream and diverted in to a defective product collecting bin 8.

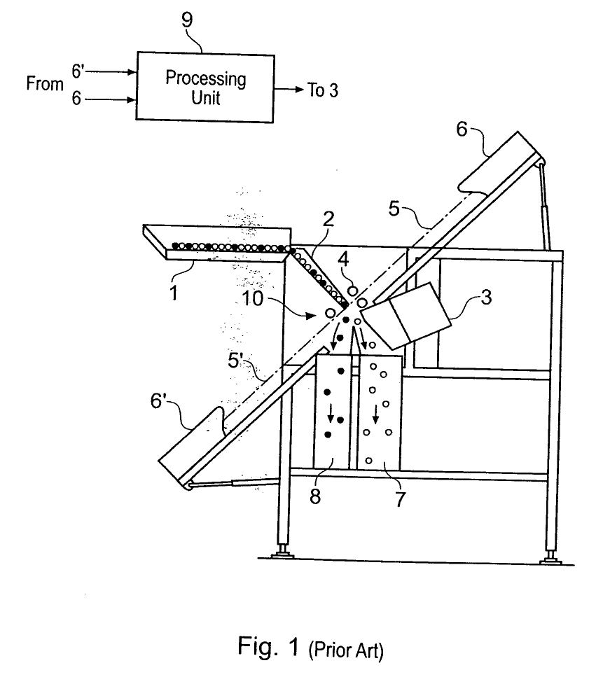

As so far described, the sorter of FIG. 2 is generally similar to the prior art sorter of FIG. 1 and operates generally in the same way.

The sorter of FIG. 2 differs from the sorter of FIG. 1 and other prior art sorters in that the blast bar 3 is positioned on the upstream side of the line of sight so that the fluid jet, in this example an air jet or jets produced by the blast bar 3 passes through the line of sight 5, 5′ of the cameras before impinging on the product stream falling through the sorting zone 10.

In other words, the zone 11 at which the fluid jet produced by the blast bar 3 impinges on the product stream is at the downstream side of the line of sight end 21 of the incline chute 2 whilst the blast bar 3 itself is on the upstream side of the line of sight.

By placing the blast bar 3 in that position, it is found that it can place the impingement zone 11 closer to the line of sight 10. That reduces the distance the product stream moves between the line of sight at which defective products are detected and the impingement zone 11 at which defective products are ejected from the stream.

Some products are highly non-uniform, for example food products contaminated by leaves, seeds or other impurities. The time taken by the impurities to move from the line of sight to the impingement zone varies and the greater the distance between the line of sight and the impingement zone the greater the variation in time for arrival of the impurities at the impingement zone 11. The blast bar 3, however, is controlled on the assumption that defective products and impurities take a fixed time to travel from the line of sight 5, 5′ to the impingement zone 11. By arranging the blast bar 3 above the line of sight as shown in FIG. 2 so that the impingement zone 11 is closer to the line of sight, the variation in time of arrival of detected impurities at the impingement zone 11 is reduced thereby increasing the reliability of the sorting. Also many objects (peas for example) tend to swerve as they slide/roll down a chute with the result that they may well not have travelled in a direction normal to the line of sight, so moving laterally by the time they reach to the impingement zone. In examples of the invention, the blast bar comprises a linear array of nozzles, actuated selectively by the processing unit 9 depending on the position in the image of the defective product(s). Lateral movement of the product may move it away from the nozzle selected by the processing unit. By placing the zone of impingement close to the line of sight any lateral movement of products between the line of sight and the zone of impingement is reduced improving the reliability of rejecting defective products.

Arranging the blast bar above the line of sight also allows greater flexibility in positioning the lights 6 and 6′.

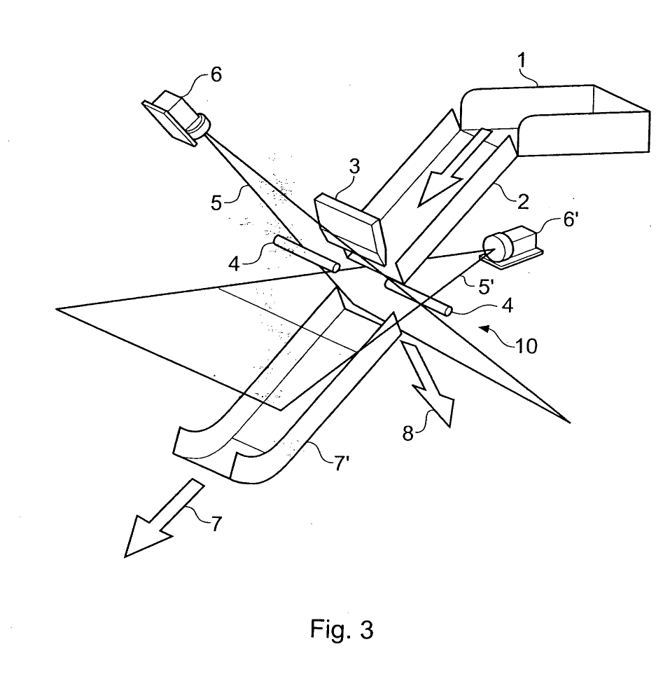

FIG. 3 shows a modification of the system of FIG. 2.

Referring to FIG. 3, the sorter of FIG. 3 differs from that of FIG. 2 mainly in that the acceptable product bin 7 is replaced by a chute 7′ and the cameras 6, 6′ are differently positioned.

As is apparent from FIG. 3, the inclined chute 2 provides a stream of products spread over the width of the chute.

The blast bar extends over the width of the chute. The blast bar comprises many individual nozzles each independently operable to produce a fluid jet.

The processor processes the outputs of the cameras in known manner to detect one or more defected products or impurities and the positions of them in the line scan direction. The processor then actuates one or more of the nozzles at a position or positions on the blast bar corresponding to the position or positions of the detected products of impurities in the line scan. If a product to be ejected moves laterally between the line of sight and the zone of impingement, then it may not be in line with the nozzle actuated by the processor when that nozzle is actuated.

The sorter of FIG. 2 operates generally in the same way as the sorter of FIG. 3.

The sorters of FIGS. 2 and 3 both have inclined chutes 2 which have a lower end close to the sorting zone for delivering the stream of product to the sorting zone. The product delivery arrangement may be a conveyor or other delivery device which delivers product to a point spaced by a predetermined distance from, and vertically above, the sorting zone. The stream then falls through the predetermined distance before entering the sorting zone.

The chutes 2 shown in FIGS. 2 and 3 are linear. They may be curved.

The blast bar of the sorters of FIGS. 2 and 3 produces an air jet. In principle the jet could be of another gas or of a liquid.

The cameras 6 and 6′ of both FIGS. 2 and 3 perform line scans across the width of the stream delivered by the chute to the sorting zone. The cameras 6 and 6′ provide an image of one line length in the line scan direction. In other embodiments the cameras may provide an image of one line length in the line scan direction and a small number, e.g. 3 lines, in the direction perpendicular to the line scan direction.

The cameras may provide colour images of the product stream as known in the art.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A sorter comprising:
a delivery device arranged to deliver a stream of product to a sorting zone through which the stream falls;
at least one camera operable to provide an image of the said stream at the sorting zone, the camera having a line of sight to the sorting zone;
a generator operable to generate a fluid jet directed at the sorting zone to impinge on the stream at a zone of impingement; and
a processor arranged to process the image provided by the said at least one camera to detect a product having predetermined characteristics and to cause the fluid jet generator to direct the fluid jet at the detected product in the zone of impingement to eject it from the stream;
wherein the zone of impingement of the fluid jet on the stream is downstream of the line of sight and the fluid jet generating means is upstream of the line of sight.

2. A sorter according to claim 1, wherein the delivery device comprises an inclined chute the lower end of which is closely adjacent the sorting zone at said opposite side of the line of sight.

3. A sorter according to claim 1, wherein the delivery device is arranged to deliver the product stream to a location vertically above, and spaced by a predetermined spacing from, the sorting zone whereby the stream falls from the location to and through the sorting zone.

4. A sorter according to claim 2, wherein the fluid jet generator has a fluid jet outlet arrangement upstream of the line of sight and adjacent to the lower end of the chute.
